(19) United States
(12) Patent Application Publication
(10) Pub. No.: US 2019/0368593 A1
(43) Pub. Date: Dec. 5, 2019

(54) VARIABLE TORQUE DIFFERENTIAL

(71) Applicants: Grigorios Kontopoulos, Frankfurt am Main (DE); Florentina Kontopoulos, Frankfurt am Main (DE)

(72) Inventor: Konstantinos KONTOPOULOS, Frankfurt am Main (DE)

(21) Appl. No.: 16/380,443

(22) Filed: Apr. 10, 2019

(30) Foreign Application Priority Data
May 30, 2018 (DE) 10 2018 208 586.2

(51) Int. Cl. F16H 48/36; F16H 48/11

(52) U.S. Cl. CPC F16H 48/36; F16H 48/11

(57) ABSTRACT

The present invention relates to a differential, and in particular to an automotive differential, for transferring a rotational force from an input member, for example connected to an automotive engine, to a first and a second output member, for example half-shafts of a drive axle of a vehicle. The differential thereby comprises a first gear connected to the first output member, a second gear connected to the second output member, and a third gear engaging both the first and second gear.

### 1. TECHNICAL FIELD

The present invention relates to a differential, in particular an automotive differential, a method for operating such a differential, and a vehicle comprising such a differential.

### 2. TECHNICAL BACKGROUND

When a wheeled vehicle, such as an automobile, turns, an outer wheel (i.e. a wheel travelling around the outside of the turning curve) typically rotates with greater speed compared to an inner wheel, as the outer wheels have to roll further than the inner wheels. For this purpose, a differential is typically applied which allows for the outer drive wheel to rotate faster than the inner drive wheel during a turn.

The basic differential is the so-called open differential, by which the torque from an engine is equally divided to each wheel. The rotational speed may differ for each wheel, wherein the average of the rotational speed of the driving wheels equals the input rotational speed provided by the engine. An increase of speed of one (outer) drive wheel is thus balanced by a respective decrease of speed of the other (inner) drive wheel.

Upon turning, the weight of a vehicle such as a car is typically transferred to the outer wheels, due to inertia effects. As a result, the outer wheels have a greater friction compared to the inner wheels. For the inner wheels, friction and traction decreases. As will be appreciated by the person skilled in the art, upon driving turns, the outer wheels can handle increased amount of engine torque with equivalent decrease in the amount of torque handled by the inner wheels. As an open differential equally divides the torque to the wheels, there is a chance that the inner wheels spin or that understeering phenomena or oversteering phenomena occur, especially when the vehicle accelerates while turning.

Furthermore, when a wheel faces a low friction surface (e.g. a muddy or an icy road), the equal distribution of the torque to the wheels is disadvantageous, as the torque transferred to the wheel on the low friction surface is the same as the one transferred to the wheel on the higher friction surface.

In order to address these problems, different systems have been developed, where the differential can for example “lock”. Such a locking differential may restrict each of the two wheels on an axle to the same rotational speed without regard to available traction or differences in resistance seen at each wheel.

The prior art systems may be divided in torque-sensitive differentials, which use mechanical friction of the parts in order to create the adequate torque difference between the half-shafts, and in differentials using friction discs. The torque-sensitive differentials transfer torque to the wheels rotating with a smaller rotational speed, while the differentials using friction discs calculate the difference of the rotational speed of the wheels and engage or disengage the friction discs accordingly.

However, there still exists a need for distributing torques to the wheels in an optimal manner. It is thus an objective of the present invention to provide an improved differential, particularly to overcome the above-mentioned deficiencies.

The present invention provides a solution according to the subject matter of the independent claims.

### 3. SUMMARY OF THE INVENTION

The invention relates to a differential, and in particular to an automotive differential. The differential may thereby allow for transferring a rotational force from an input member (which may be an input shaft or drive shaft connected to an automotive engine) to a first and a second output member (which may be half-shafts of a drive axle). The differential may also be provided in form of a central differential in all wheel drive (AWD) vehicles, to distribute torques/rotational forces between the front and rear axle.

The differential comprises a first gear connected to the first output member, and a second gear connected to the second output member. The first and second gear may thereby be non-rotatably connected to the respective output member, i.e. may be connected in a rotationally fixed manner to the respective half-shafts. Thus, when the first gear rotates, also the first output member or respective half-shaft rotates. The first and second gear may be provided in form of a pinion, for example.

The differential further comprises a third gear, engaging both the first and second gear. The third gear may thereby be connected to the input member, non-rotatably, i.e. in a rotationally fixed manner. Hence, for example, if the input shaft rotates, also the third gear connected thereto rotates. Due to the engagement of the third gear with the first gear and second gear, a rotational force from the input member may be transferred via the third gear and first/second gear to the first/second output member.

The differential further comprises first actuating means adapted to move the first gear to control a first torque transferred to the first output member. Thus, by moving the first gear, the first torque may be set to a desired value. Moving the first gear may thereby comprise repositioning, reorienting or realigning the first gear. By moving the first gear, using the first actuating means, it is possible to change (for a given input force applied to the differential) the first torque transferred to the first output member, so that a torque may be applied to the first output member different from a torque applied to the second output member. Thereby, a desired first torque may be transferred to the first output member or the respective half-shaft, without internal energy consumption due to friction losses, and without interactions or interferences with other systems like ABS, ESP, ASR, and the like. By controlling the first torque transferred to the first output member with the first actuating means, oversteering and understeering phenomena can be effectively reduced by decreasing the possibility of spinning wheels, so that it is possible to drive turns in a safer, easier and also faster manner.

Preferably, a desired torque ratio between the first and second output member can be set by means of the first actuating means. The desired torque ratio, which may be defined by the ratio of the higher one of the torques applied to the two output members divided by the lower one, may preferably be in the range of 1 to 20, further preferred in the range of 1.01 to 10, further preferred in the range of 1.05 to 5, further preferred in the range of 1.1 to 3, further preferred in the range of 1.2 to 2. By moving the first gear in a predefined range, a respective predefined range of torque ratios can be set.

The person skilled in the art understands that an additional degree of freedom may be provided for the differential, in order for the torques to change when moving the first gear. As an example, the third gear may be provided such that the orientation of the third gear is not fixed with regard to the orientation of the first and/or second gear. For example, the third gear may be provided such that its main axis can be reoriented, if only by small amounts. Hence, the third gear may be freely mounted in the differential, with regard to the first and/or second gears, allowing for the additional degree of freedom. When the input member acts on the third gear, and to the engagement of the third gear with the first gear and the second gear, forces act on the third gear which eventually result in a particular torque ratio transferred to the output members. Hence, due to differing positions of the first and second gear in the differential, rotary forces may act on the third gear, eventually leading to differing forces and torques transferred from the third gear to the first and second gears.

Preferably, the third gear of the differential is configured movable in a plane orthogonal to a radial direction of the first gear. Thus, moving the first gear by means of the first actuating means may, when external forces are applied to the differential (e.g. by an engine), may urge the third gear to rotate around an axis which may differ from a main rotation axis of the third gear, thereby eventually transferring differing forces to the first and second gears. Moving the first gear may hence cause a reconfiguration of the differential, in particular of the third gear, which essentially results in a particular torque ratio between the first and second output member. The person skilled in the art thereby understands that by introducing a further degree of freedom into the system, by configuring the third gear to be movable as described, different torques can be set by moving the first gear. Eventually, by allowing for such an additional movement when axially moving the first gear, the force transferred by the third gear to the first gear may differ from the force transferred by the third gear to the second gear, thus favorably leading to a desired torque ratio.

In a preferred embodiment, the first, second and third gear form a sun and planetary gear system. Thereby, the third gear may be provided as a planetary gear, and the first gear may be provided as a sun gear, and the second gear may also be provided as a sun gear. The structure (e.g. radius, number of gear teeth, etc.) of the first gear may be the same as the structure of the second gear. The first gear may thereby be axially movable relative to the third gear between at least a first and a second axial position. Thus, the first gear may be moved along a main axis of the first output member. A distance between the first axial position to a center of the differential may thereby be different to a distance between the second axial position and the center of the differential. The first actuating means may be adapted to move the first gear between at least the first and the second axial position. As the transferred driving forces applied to the first gear via the sun and planetary gear system may depend on the distance of the first gear in relation to the center of the differential, it is thus possible to eventually adjust the first torque transferred to the first output member by moving the first gear, particularly by changing the axial position of the first gear. The first gear may thereby be moved axially by the first actuating means to a desired position, corresponding to a desired torque.

The person skilled in the art understands that the first gear may be axially movable between more than two axial positions. The first gear may preferably be quasi-continuously axially movable between numerous axial positions, preferably between at least 10 positions, further preferred between at least 50 positions, further preferred between at least 100 positions. Each of the axial position may essentially correspond to a respective torque.

It will be appreciated that no particular torque values in each one of the first and second output members may be set, but rather desired torque ratios therebetween. For a constant number of engine revolutions of a vehicle, depending on the throttle, the total torque is constant. When changing the position of the first gear provided as a sun gear, the transferring torque ratio is altered in each output member, wherein the sum of the resulting torques acting on the output members equals the total torque provided by the engine.

Preferably, the differential further comprises a housing engageable by the input member. Hence, the input member may engage the housing to transfer a rotational force to the differential. The third gear may be rotatably connected to the housing. Further preferred, the housing may support the planetary gear, and the planetary gear may comprise a first planetary gear member and a second planetary gear member. The planetary gear members may each rotate around a main axis thereof. The first planetary gear member may be engaged by the first gear, and the second planetary gear member may be engaged by the second gear. Further preferred, the differential further comprises a connection part connecting the first planetary gear member and the second planetary gear member. The connection part may thereby be configured movable relative to the housing in a plane orthogonal to a radial direction of the first gear, and the connection part may be supported in the housing to be movable as described. Hence, preferably, the connection part allows for rotation in a plane orthogonal to a radial direction of the first gear. The connection part may have any suitable shape and/or form to provide this functionality. This configuration allows for a reconfiguration of the differential when moving the first gear, whereby essentially a particular torque ratio may be set. Moving the first gear may case a movement of the connection part. As the planetary gear members are supported by the connection part, essentially a different force is transferred via the planetary gear to the first gear than to the and the second gear. Hence, the first torque transferred to the first output member may eventually differ from a second torque transferred to the second output member, resulting in a desired torque ratio.

Further preferred, the connection part may have an elongated form, having rounded ends. The connection part may thereby be provided in the housing such that it directly receives torques from the housing, preferably without any slippage, in a plane orthogonal to a main axis of the differential, or a main axis of the first gear and the first output member. The main axis of the differential may be defined by the main axis of the output members. The rounded ends may allow for a movement of the connection part in a plane orthogonal to a radial direction of the first gear. The connection part may rotate inside a recess provided in the housing. Thus, an additional degree of freedom is provided in a robust manner to the differential, allowing for reconfiguring the differential by moving the first gear.

Further preferred, the connection part has a rectangular cross section. This may provide for transferring torques from the housing to the planetary gear in a reliable and robust manner.

Further preferred, the first planetary gear member extends through a first hole of the connection part, and the second planetary gear member extends through a second hole of the connection part. Thereby a particularly reliable support of the planetary gear is provided, and forces and torques can be efficiently transferred from the housing via the connection part to the planetary gear members.

Preferably, the first actuating means comprises a connection to external driving means. The external driving means may, for example, comprise a hydraulic pump, which may be part of a steering system of a car. Thus, in this example, when the steering system is operated to initiate a turn, the hydraulic pump may assist the motion of turning the steering wheel. In doing so, the hydraulic pump may also act on the first actuating means, thereby moving the first gear. The first actuating means may further comprise a spring adapted to move the first gear in an opposite direction. Hence, the first gear may be axially moved back and forth by means of the external driving means, and the spring. In another preferred embodiment, the external driving means may particularly comprise a tie rod of a vehicle. Thus, by moving the tie rod, for example when initiating a turning movement of the vehicle, the tie rod may act on the first actuating means to eventually move the first gear. The person skilled in the art may understand that only the tie rod may urge the first gear to move forth and back, or a double action hydraulic cylinder may provide this function, for example.

Preferably, the differential may further comprise a first splined rail supporting the first gear and comprising axially elongated holes, wherein the first gear may be axially movable along the first splined rail. The first actuating means may thereby comprise actuator pins extending through the holes of the first splined rail to the first gear. The provision of the first splined rail between the first gear and preferably the respective half-shaft allows for ensuring a secure mounting of the first gear, and a smooth axial movement of the first gear along the first splined rail, and thus along the first output member. The provision of the first splined rails further ensures that the length of the half-shaft is unchanged, independent of the position of the first gear.

Generally preferred, the first actuating means are adapted to move the first gear based on driving conditions. The driving conditions may thereby comprise speed, acceleration, wheel turning characteristics, and also a current inclination angle of the road, and so on. Such data may be collected by means of respective sensors, and may be processed in a respective computing unit. Thereby, an optimum torque combination for the wheels may be determined, and a respective command may be provided to the first actuating means for move the first gear accordingly.

Preferably, the differential further comprises second actuating means corresponding to the first actuating means, wherein the second actuating means are adapted to move the second gear to control a second torque transferred to the second output member. The person skilled in the art understands that the second actuator means may thereby be analogous to the first actuating means, but assigned to the second gear and second output member. Thereby, it is possible to set desired torques to each one of the half-shafts separately and independently.

Preferably, the first actuating means are adapted to move the first gear such that the first torque transferred to the first output member is different from a second torque transferred to a second output member. Thus, it is possible to apply different torques to the wheels. Thus, a desired torque ratio can be set. When not desired, equal torques can be provided to the two output members. When there is a need for torque variation between the two output members, a desired torque ratio can be set.

The present invention further relates to a method for operating a differential, wherein the differential may be in accordance with a differential set out above. The method thereby comprises the steps of determining a first torque to be transferred to the first output member of the differential, and moving the first gear based on the determined first torque, so that the first torque is eventually transferred to the first output member. Preferably, the method further comprises the step of sensing driving conditions, and the step of determining the first torque may be based on the sensed driving conditions.

Preferably, the first torque is different from a second torque transferred to the second output member.

The present invention further relates to a vehicle comprising a differential according to a differential set out above. The differential may thereby be provided in a front drive axle, rear drive axle, and/or as a central differential in an AWD vehicle.

The present invention allows for easier and safer driving, easier parking, and the ability to take turns faster by reducing the phenomena of understeering or oversteering, as different torques can readily be applied to different drive wheels. For example, when reverse parking, an increased torque can be provided to the outer drive wheel, to facilitate turning. Furthermore, as the torques of the drive wheels can be individually controlled, less tire wear occurs, and economy is improved. Furthermore, torques can be distributed in a desired manner between the front and the rear wheels in an a AWD vehicle, and by providing three differentials according to the present invention, each wheel of an AWD vehicle can be provided with an individual torque.

### 4. DESCRIPTION OF PREFERRED EMBODIMENTS

In the following, the present invention will be described with reference to the figures. Therein, similar elements are provided with same reference numbers. It shows:

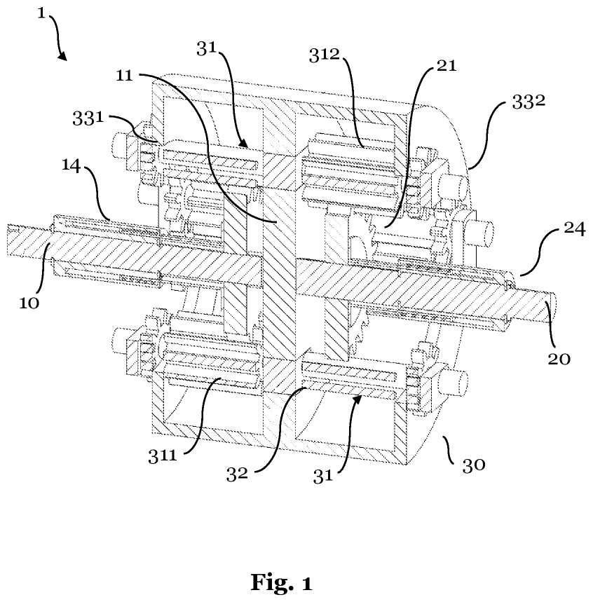

FIG. 1 a sectional view of a differential according to an embodiment of the invention;

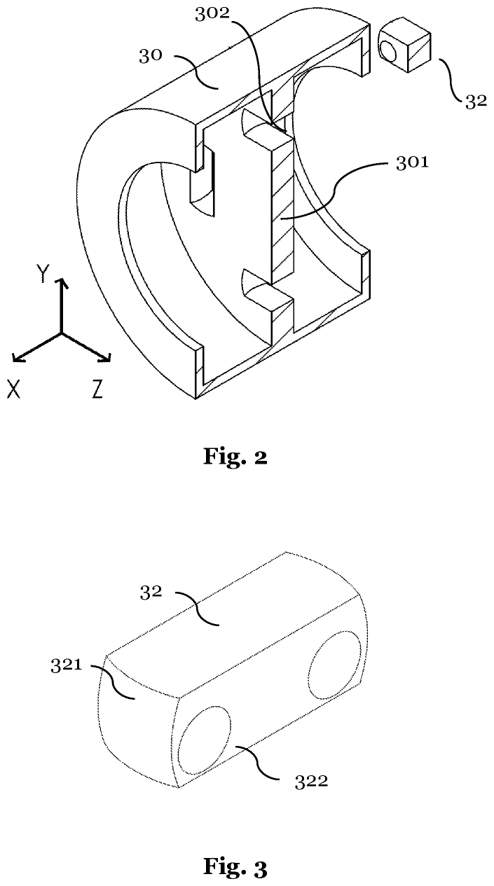

FIG. 2 a sectional view of individual parts of a differential according to the embodiment illustrated in FIG. 1;

FIG. 3 a connection part of a differential according to the embodiment illustrated in FIG. 1;

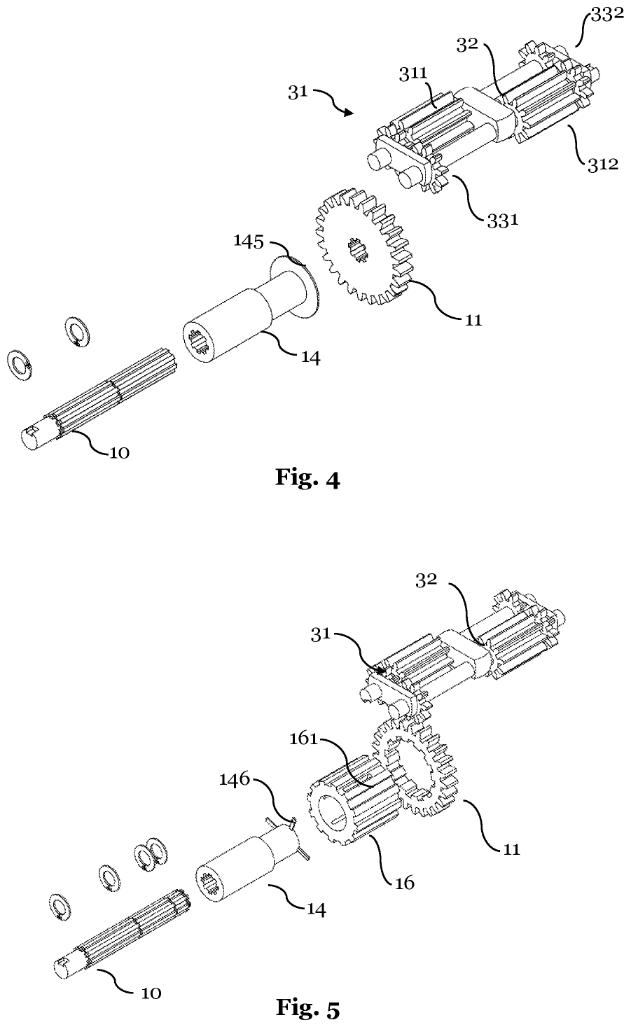

FIG. 4 individual parts of a differential according to the embodiment illustrated in FIG. 1;

FIG. 5 individual parts of a differential according to a further embodiment of the invention;

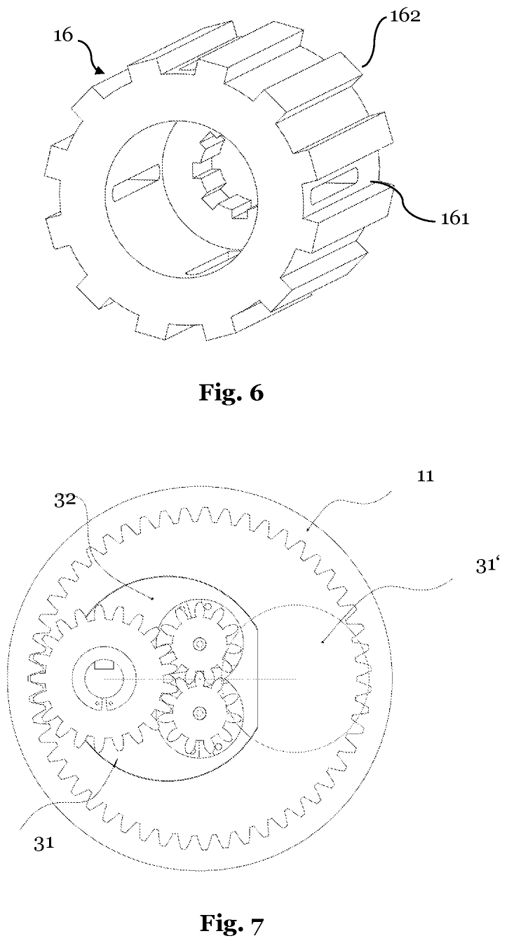

FIG. 6 a splined rail of a differential according to the embodiment illustrated in FIG. 5;

FIG. 7 a cross-sectional view of a differential according to a further embodiment of the invention;

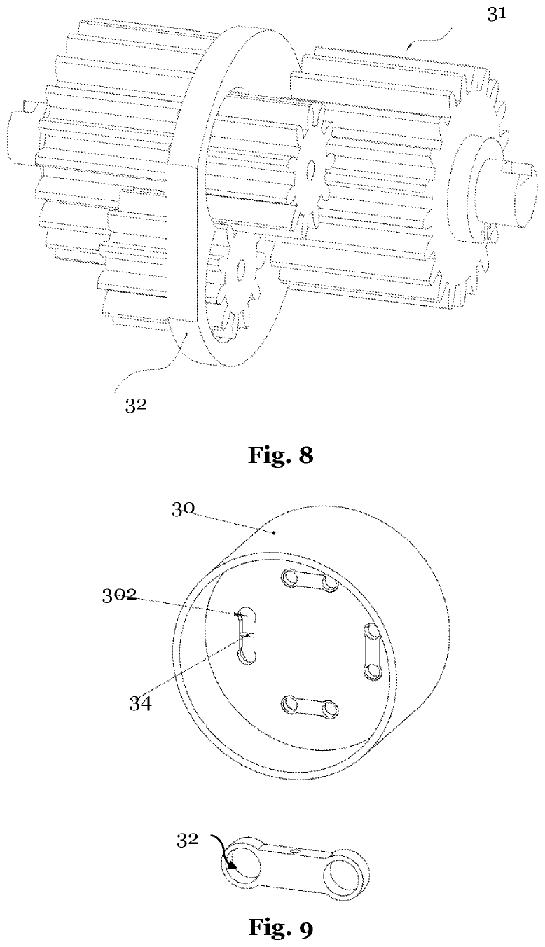

FIG. 8 individual parts of a differential according to the embodiment illustrated in FIG. 7;

FIG. 9 individual parts of a differential according to a further embodiment of the invention;

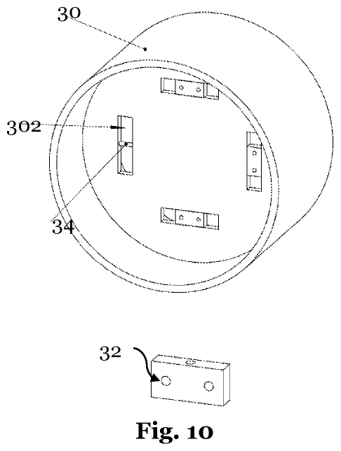

FIG. 10 individual parts of a differential according to a further embodiment of the invention.

FIG. 1 illustrates a sectional view of a differential 1 according to an embodiment of the invention. The differential 1 is thereby provided as a sun and planetary gear system. A first half-shaft 10 is connected to a first sun gear 11 in a rotationally fixed manner. Hence, when the first half-shaft 10 rotates, the first sun gear 11 rotates in a similar manner. Similarly, a second half-shaft 20 with a second sun gear 21 are provided. The sun gears 11, 21 are provided in a housing 30 of the differential 1, which further houses several planetary gears 31. The housing 30 may be engaged by a drive shaft, for example, connected to an engine as will be appreciated by the person skilled in the art. For example, the housing 30 may be rotated by engaging a crown wheel with a drive shaft of a vehicle. A differential ring gear may be concentrically attached to the differential housing 30 of the differential 1 accompanied by a drive pinion, for transferring rotations from an engine to the differential 1.

The person skilled in the art understands that the planetary gears 31 of a sun and planetary gear system may comprise planetary gear shafts and spur gears for transferring forces and torques. Each planetary gear 31 comprises a first planetary gear member 311 and a second planetary gear member 312. For providing the general functionality of a differential, the first planetary gear member 311 is engaged by the first sun gear 11, while the second planetary gear member 312 is engaged by the second sun gear 21, and the first planetary gear member 311 is rotatably connected to the second planetary gear member 312. The first and second planetary gear members 311, 312 are supported within the housing 30. A connection part 32 is provided, connecting the shafts of the planetary gears 31 being engaged by the sun gears 11, 21. The connection part 32 provides for a fixed orientation of the first planetary gear member 311 relative to the second planetary gear member 312. Further, two supporting links 331, 332 are provided at the ends of the planetary gear members 311, 312, which also allow for retaining the distance between the planetary gear members 311, 312. The ends of the planetary gear members 311, 312 are not fixed to the housing 30. As will be appreciated by the person skilled in the art, when the housing 30 is forced to rotate, forces and torques are applied via the connection part 32 to the planetary gear shafts. In the embodiment illustrated in FIG. 1, the planetary gears 31 can move or reorient relative to the housing 30 in a plane orthogonal to a radial direction of the sun gears 11, 21. Thereby, an additional degree of freedom is provided.

Furthermore, as shown in FIG. 1, a first actuator 14 is provided on the first half-shaft 10, engaging the first sun gear 11. Similarly, a second actuator 24 is provided on the second half-shaft 20, engaging the second sun gear 21. The actuators 14, 24 may be mechanically driven, electrically driven, and/or, hydraulically driven. For example, the actuators 14, 24 may be connected to a hydraulic pump of a hydraulic steering system, or may be connected to a tie rod of a vehicle. The actuators 14, 24 are thereby each adapted to move the respective sun gear 11, 21 along the respective half-shaft 10, 20. As will be appreciated by the person skilled in the art, by moving the sun gears 11, 21 by means of the actuators 14, 24, the transferred driving forces applied onto the sun gears 11, 21 via the planetary gears 31 changes, depending on the distance of the sun gears 11, 21 in relation to the center of the differential 1. By repositioning the sun gears 11, 21 in each half-shaft 10, 20, a different torque ratio is being set, due to different forces applied from the planetary gears 31 to the sun gears 11, 21.

As will be appreciated by the person skilled in the art, when moving the first sun gear 11, the planetary gears 31 are urged to reposition, due to the additional degree of freedom mentioned above. By means of the first actuator 14, the distance of the first sun gear 11 to the center of the differential may be set to be less than the distance of the second sun gear 21 to the center of the differential. When the housing 30 is forced to rotate, e.g. by an engine, a force acts on the connection part 31. When transferring the forces to the planetary gear members 311, 312, the connection part 31 “feels” the closer distance of the first sun gear 11. As the connection part 31 is not fully fixed to the housing 30, but could generally rotate in the plane orthogonal to a radial direction of the sun gears 11, 21, a higher force is eventually acting on the first sun gear 11 via the first planetary gear member 311.

Generally, the forces applied by the planetary gears 31 to the sun gears 11, 21 may be described as follows, with force F1 acting on the first sun gear 11, force F2 acting on the second sun gear 21, the distance d1 of the first sun gear 11 to the center of the connection part 31, and the distance d2 of the second sun gear 21 to the center of the connection part 31:

F1×d1=F2×d2 (Eq. 1)

As the sun gears 11, 21 have equal radii r, the resulting torque ratio M1/M2 may be described as follows:

M1/M2=(F1×r)/(F2×r) (Eq. 2)

When introducing Eq. 1 into Eq. 2, the resulting torque ratio may be described as follows:

M1/M2=d2/d2 (Eq. 3)

Hence, by moving the sun gears 11, 21, a desired torque ratio can be set. When moving straight forward, the sun gears 11, 21 on each half-shaft 10, 20 may be located in the same position relative to the center of the differential 1, or of the differential housing 30. Upon turning, an optimum torque combination may be calculated by a central computing unit, and a respective command may be given to one or both of the actuators 14, 24 to move the sun gears 11, 21 individually to the desired position. As a result, different forces are applied to the sun gears 11, 21 by the planetary gears 31, and as a consequence different torques are assigned to the respective half-shafts 10, 20.

FIG. 2 illustrates a sectional view of the housing 30 according to the embodiment of FIG. 1. A central frame 301 of the housing 30 comprises several recesses 302, into which the connection parts 32 are placed, as also illustrated in FIG. 1. As can further be depicted from the housing 3o illustrated in FIG. 2 in combination with the illustration of FIG. 1, the planetary gears 31 are mainly supported by means of the connection parts 32 in the central frame 301 of the housing 30. A rotational movement of the connection part 32 in the X-Z plane, i.e. the plane orthogonal to the radial direction of the first gear 11, is hence generally allowed. This provides for an additional degree of freedom of the differential 1.

FIG. 3 illustrates a connection part 32, as exemplarily used in the differential 1 according to the embodiment of FIG. 1. The connection part 32 has a generally elongated form, and has rounded ends 321. Further, the connection part has a rectangular cross section. Further, two passages 322 are provided, through which the planetary gear members 311, 312 may extend. Due to the particular shape of the connection part 32, when introduced in the housing 30, torques acting in the Y-Z plane (cf. FIG. 2) can be transferred to the planetary gears 31. The rounded ends 321 of the connection part 32 allow for a rotational movement of the connection part 32, and hence of the planetary gear members 311, 312 inserted in the passages 322 of the connection part 32, in the X-Z plane (cf. FIG. 2). Different forms/shapes of a connection part 32 will be presented further below.

The skilled person understands that although the connection part 32 may be urged to rotate, the connection part 32 must not necessarily rotate as a result thereof. Instead, even though the connection part 32 could basically rotate, it is hindered by the engagement of gear teeth of the first planetary gear member 311 with the first sun gear 11 (and similarly by the engagement of the gear teeth of the second planetary gear member 312 with the second sun gear 21). Hence, instead of actually rotating in the X-Z plane (cf. FIG. 2), the connection part 32 forces the first planetary gear member 311 (and similarly the secondary planetary gear member 312) to rotate around its axis, on top of the sun gears 11, 21. Thereby, eventually different torques are transferred to the half-shafts 10, 20. FIG. 4 illustrates individual parts of the differential 1 of FIG. 1. The actuator 14 has a splined hole, which is in communication with a splined outer surface of the half-shaft 10. Similarly, also the sun gear 11 has a splined hole connected to the half-shaft 10. Thus, the half-shaft 10, the sun gear 11 and the actuator 14 are rotationally fixed to each other. The actuator 14 further comprises an actuator moving disc 145, which is connected to the sun gear 11 for moving it axially along the half-shaft 10.

FIG. 5 illustrates individual parts of a differential according to a further embodiment of the invention, which to a large extent correspond to the embodiment illustrated in FIG. 4. In addition, a splined rail 16 is provided on the actuator 14. The splined rail 16 thereby comprises an outer splined surface, which can communicate with or engage an inner splined hole of the sun gear 11. Furthermore, several axially elongated holes 161 are provided on the splined rail 16.

The person skilled in the art understands that the features described with regard to FIG. 4 and FIG. 5 may apply to both half-shafts of a differential, for example to both half-shafts of the differential 1 shown in FIG. 1.

Further according to FIG. 5, the actuator 14 comprises actuator pins 146, which can be axially moved by the actuator 14. The actuator pins 146 extend through the holes 161 of the splined rail 16, and are connected to the sun gear 11. The provision of the splined rail 16 allows for a secure movement of the sun gear 11, due to the increased gliding surface, as the sun gear 11 is in direct contact with the splined rail 16 and not with the half-shaft 10. Further, the provision of the splined rail 16 allows for a constant length of the half-shaft 10, independent of the position of the sun gear 11.

FIG. 6 illustrates a splined rail 16, which may correspond to the splined rail 16 in the embodiment illustrated in FIG. 5. The splined rail 16 of FIG. 6 comprises exemplarily twelve outer elongated cogs 162, which are uniformly provided around the splined rail 16. The cogs 162 interact with the inner splined hole of the sun gear 11, to transfer rotary forces. The cogs 162 are thereby provided with a cross section having a Π shape. Further, as an example, four axially elongated holes 161 are uniformly provided around the splined rail 16, each one provided between two neighboring cogs 162. When provided as the splined rail 16 in FIG. 5, the actuator pins 146 of the actuator 14 may extend through these holes 161 to engage the sun gear 11, for axially moving the sun gear 11. For example, the actuator pins 146 may engage one face of the sun gear 11, or may engage respective cavities in the sun gear 11. The person skilled in the art understands that the elongated holes 161 may also or alternatively be provided on the cogs 162 of the splined rail 16.

FIG. 7 illustrates a cross-sectional cut of a differential according to a further embodiment of the invention. The cross-sectional cut is thereby such that the half-shafts extend orthogonal to the illustrated cut. In the embodiment illustrated in FIG. 7, a first gear is provided as a first internal spur sun gear 11, engaging a planetary gear 31 provided inside the first internal spur sun gear 11. The person skilled in the art understands that the differential comprises a corresponding second internal spur sun gear (not visible in FIG. 7), which is of the same structure as the first sun gear 11. The internal spur sun gears can further be moved along the respective half-shafts by means of respective actuators, as described above. If desired, the differential can be strengthened by providing a further gear to the planetary gear 31, at the marked blank position 31′.

Further, a connection part 32 is provided, which provides for the same functionality as described above. In particular, the connection part 32 may provide for an additional degree of freedom, as the connection part 32 may rotate in a plane orthogonal to a radial direction of the first internal spur sun gear 11.

FIG. 8 illustrates individual parts of the differential illustrated in FIG. 7. As can be seen from the illustration in FIG. 8, the connection part 32 comprises rounded edges, which allow for the rotational movement thereof inside a housing (not illustrated). The person skilled in the art understands that the concepts described above with regard to the embodiments illustrated in FIGS. 1-6 similarly apply to the embodiments illustrated in FIGS. 7-8. Hence, as described above with regard to the other embodiments, different torques can eventually be provided to the half-shafts, by moving the internal spur sun gears to the desired axial positions and thereby urging the connection part 32 to rotate. As mentioned above, the connection part 32 does not bear any torque in a plane orthogonal to a radial direction of the first gear. Hence, although the connection part 32 could rotate in the plane, it will basically not do so, due to the engagement with the gear teeth. Therefore, the connection part 32 will force the gears to rotate, so that eventually different torques are transferred to the half-shafts.

The person skilled in the art hence understands that the concept of setting a desired torque ratio is not limited to a sun and planetary gear system as illustrated exemplarily in FIG. 1, but can also be applied to other setups of differentials, such as the one illustrated in FIGS. 7-8.

FIG. 9 illustrates a housing 30 and a connection part 32, which may exemplarily be used in the differential 1 according to the embodiment of FIG. 1, as will be appreciated by the person skilled in the art. Here again, the connection part 32 is provided in respective recesses 302 of the housing 30. The recesses 302 have a similar shape as the connection parts 32, allowing for a rotation thereof as described herein. The endings of the connection parts 32 are rounded, and are provided with holes providing particular strength to the setup. Further, a rotation axis 34 is provided in the recess 302, which supports the connection part 32 when provided in the recess 302. The rotation axis 34 thereby allows for a rotation of the connection part 32 as described here, preferably in a plane orthogonal to a radial direction of sun gears, e.g. the sun gear 11 of FIG. 1.

FIG. 10 illustrates a further embodiment, with a housing 30 and a connection part 32, which may again exemplarily be used in the differential 1 according to the embodiment of FIG. 1, as will be appreciated by the person skilled in the art. The description with regard to FIG. 9 similarly applies here. The connection parts 32 are, however, provided with a different shape, which is now of an angular shape, without rounded edges. The recesses 302 are dimensioned to be larger than the connection parts 32, regarding the elongated extension of the connection parts 32, thereby allowing for the rotation of the connection parts 32. Thereby, the additional degree of freedom is provided to the system, as described herein.

1. A differential, in particular an automotive differential, for transferring a rotational force from an input member to a first and a second output member, comprising:
a first gear connected to the first output member;
a second gear connected to the second output member;
a third gear engaging both the first and second gear; and
first actuating means adapted to move the first gear to control a first torque transferred to the first output member.

2. The differential of claim 1, wherein the third gear is configured movable in a plane orthogonal to a radial direction of the first gear.

3. The differential of claim 1,
wherein the first, second and third gear form a sun and planetary gear system,
wherein the third gear is provided as a planetary gear,
wherein the first gear is provided as a sun gear axially movable relative to the third gear between at least a first and a second axial position, wherein a distance between the first axial position to a center of the differential is different to a distance between the second axial position and the center of the differential,
wherein the first actuating means are adapted to move the first gear between at least the first and the second axial position.

4. The differential of claim 3, further comprising a housing engageable by the input member,
wherein the housing supports the planetary gear,
wherein the planetary gear comprises a first planetary gear member and a second planetary gear member,
wherein the first planetary gear member is engaged by the first gear and the second planetary gear member is engaged by the second gear,
the differential further comprising a connection part connecting the first planetary gear member and the second planetary gear member,
wherein the connection part is configured movable relative to the housing in a plane orthogonal to a radial direction of the first gear.

5. The differential of claim 4, wherein the connection part allows for rotation in a plane orthogonal to a radial direction of the first gear.

6. The differential of claim 4, wherein the connection part has an elongated form having rounded ends and/or wherein the connection part has a rectangular cross section.

7. The differential of claim 4, wherein the first planetary gear member extends through a first hole of the connection part, and wherein the second planetary gear member extends through a second hole of the connection part.

8. The differential of claim 1, wherein the first actuating means comprises a spring and/or a connection to external driving means, in particular wherein the external driving means comprise a tie rod or a hydraulic pump of a vehicle.

9. The differential of claim 1, further comprising
a first splined rail supporting the first gear comprising axially elongated holes, wherein the first gear is axially movable along the first splined rail,
wherein the first actuating means comprise actuator pins extending through the holes of the first splined rail to the first gear.

10. The differential of claim 1, wherein the first actuating means are adapted to move the first gear based on driving conditions.

11. The differential of claim 1, further comprising second actuating means corresponding to the first actuating means, wherein the second actuating means are adapted to move the second gear to control a second torque transferred to the second output member.

12. The differential of claim 1, wherein the first actuating means are adapted to move the first gear such that the first torque transferred to the first output member is different from a second torque transferred to the second output member.

13. A method for operating a differential according to claim 1, comprising:
determining a first torque to be transferred to the first output member; and
moving the first gear, based on the determined first torque, so that the first torque is transferred to the first output member.

14. The method of claim 13, further comprising the step of sensing driving conditions, and wherein the step of determining the first torque is based on the sensed driving conditions.

15. The method of claim 13, wherein the first torque is different from a second torque transferred to the second output member.

16. The vehicle comprising a differential according to claim 1.
